(19) United States
(12) Patent Application Publication
(10) Pub. No.: US 2008/0121286 A1
(43) Pub. Date: May 29, 2008

(54) Commissioning Module Including an Airtight Housing

(75) Inventors: Lars Christian Fabricius, Surrey (GB); George McHugh, Berwyn, PA (US)

Correspondence Address: BUCHANAN, INGERSOLL & ROONEY PC, POST OFFICE BOX 1404, ALEXANDRIA, VA, 22313-1404, US

(73) Assignee: S.A.V. UNITED KINGDOM LIMITED, West Molesey (GB)

(21) Appl. No.: 10/589,891

(22) PCT Filed: Feb. 18, 2005
(86) PCT No.: PCT/GB05/00620

§ 371 Date: Sep. 19, 2007

(30) Foreign Application Priority Data
Feb. 19, 2004 (GB) 0403724.8

(51) Int. Cl. F16K 27/00; F24F 13/22; F24F 13/20; F17D 1/00

(52) U.S. Cl. 137/377

(57) ABSTRACT

A commissioning module including an airtight housing, in which sealing members in the vicinity of an aperture in the periphery of the housing provides an airtight seal between the periphery of the housing and a conduit passing through the aperture in the periphery of the housing.

The invention relates to a commissioning module including an airtight housing, for preventing, or at least minimising, the formation of condensate from moisture in the air in the vicinity of the commissioning module.

The invention provides a commissioning module including:

an assembly of fluid control elements including a main fluid supply port, a main fluid return port, a first fluid distribution port and a second fluid distribution port, the assembly of fluid control elements being operable to pass supply fluid from the main fluid supply port to the first fluid distribution port and to pass return fluid entering the second fluid distribution port to the main fluid return port, at a rate that may be varied by at least one of the fluid control elements,

a plurality of lengths of conduit connected to the ports of the assembly of fluid control elements,

a housing enclosing the assembly of fluid control elements, the periphery of the housing including respective apertures through which pass the plurality of lengths of conduit, the housing being airtight except for the apertures in its periphery and

a plurality of sealing members providing airtight seals between the apertures in the periphery of the housing and the respective lengths of conduit passing through the apertures.

In one arrangement, the sealing members include grommets.

In another arrangement, the sealing members include grommet sleeves.

In an alternative arrangement, the sealing members include cable glands.

Cable glands are threaded tubular members which are slid over the conduit on opposite sides of the aperture through which the conduit passes, and are screwed together to form a seal between the conduit and the aperture.

In one arrangement, a plurality of sealing members are merged into a layer of resilient material.

Preferably, the sealing members are positioned on the outer surface of the periphery of the housing.

An alternative arrangement has the sealing members positioned on the inner surface of the periphery of the housing.

Preferably, the lengths of conduit include a resilient covering layer.

Preferably, resilient covering layer is a plastics material.

Preferably, the resilient covering layer is of a foamed material.

Preferably, the sealing members are of a plastics material.

Preferably, the sealing members are of a foamed material.

Preferably, the housing includes a lid, sealing means being included for effecting an airtight seal between the lid and the remainder of the housing.

Preferably, the assembly of fluid control elements includes elements operable to effect the flushing through of the assembly.

A commissioning module including an airtight housing, in accordance with the invention, will now be described by way of example only with reference to the accompanying drawings, in which:

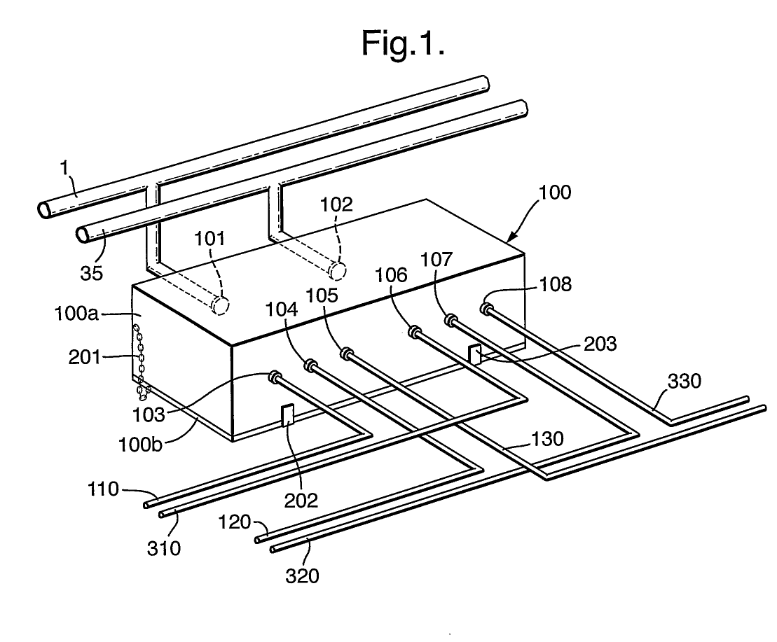

FIG. 1 represents a perspective view of the exterior of the airtight housing of a commissioning module and the associated exterior conduits connected to the commissioning module and

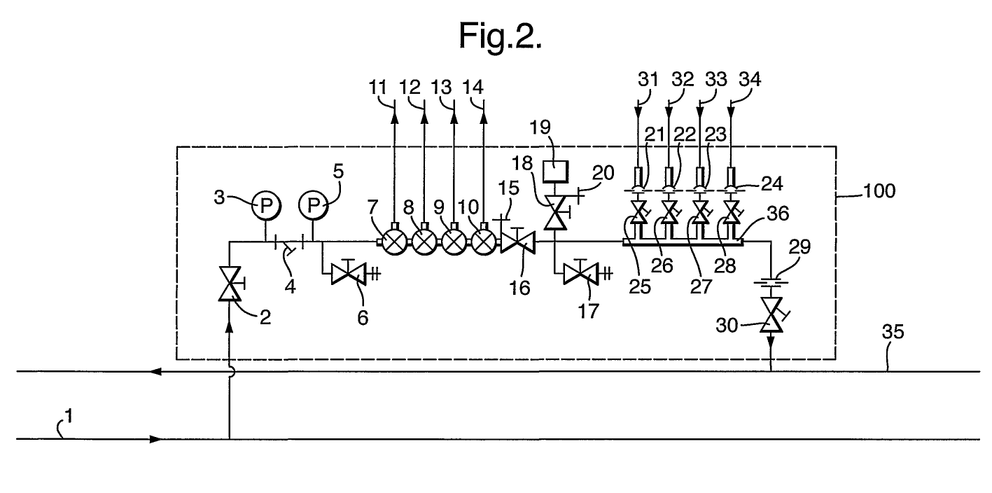

FIG. 2 is a diagrammatic representation of the components of a commissioning module which may be enclosed within the airtight housing, including fluid distribution (flow and return) conduits connected to the commissioning module.

FIGS. 3 to 6 show four possible arrangements of sealing members effecting an airtight seal in the vicinity of an aperture in the periphery of the housing through which a length of conduit passes.

Referring to FIG. 1 of the accompanying drawings, there is shown an airtight rectangular housing 100 including a main body 100a and a lid 100b which covers the open lower part (as viewed) of the main body 100a. The lid 100b is attached to the main body 100a by means of hinges (not shown) and two catches 202 and 203 provide a means of releasably securing the lid 100b to the main body 100a. Sealing means (not shown) is included at the interface between the lid 100b and the main body 100a of the housing 100 and provides an airtight seal between the lid 100b and the main body 100a of the housing 100 when the lid 100b is closed and secured by the catches 202 and 203. A length of chain 201 is connected between the lid 100b and the main body 100a of the housing 100 and serves as a safety device, when the lid 100b is allowed to swing downwards, following the release of the catches 202 and 203. A second length of chain corresponding to the length of chain 201 may be provided on the opposite side of the housing 100. Access to the interior of the housing 100 is achieved by releasing the catches 202 and 203 and allowing the lid 100b to swing downwards, as viewed in the drawing.

The housing 100 is made of galvanised steel and includes internal thermal insulation. Other materials, including non-metals, are suitable materials for the housing 100.

A length of flow conduit 1 is connected for the delivery of working fluid to the commissioning module within the airtight housing 100, passing through a first aperture in the rear bulkhead (as viewed) of the housing 100, a first sealing member 101 providing an airtight seal between the first aperture and the flow conduit 1. A length of return conduit 35 is connected for the removal of the working fluid from the commissioning module within the airtight housing 100, passing through a second aperture in the rear bulkhead of the housing 100, and a second sealing member 102 provides an airtight seal between the second aperture and the return conduit 35.

A length of first fluid distribution conduit 110 is connected for delivery of the working fluid from the commissioning module within the airtight housing 100 to a first service, for example, a fan coil, and a length of second fluid distribution conduit 310 is connected for return of the working fluid from the service to the commissioning module within the airtight housing 100. The lengths of first and second distribution conduits 110 and 310 pass through respective apertures in the front bulkhead (as viewed) of the airtight housing 100 and respective third and fourth sealing members 103 and 106 provide airtight seals between the lengths of conduit 110 and 310. There are also sealing members 104 and 107 providing airtight seals between respective lengths of third and fourth fluid distribution conduits 120 and 320 and the apertures in the airtight housing 100 through which the lengths of third and fourth fluid distribution conduits 120 and 320 pass. Further, there are sealing members 105 and 108 providing airtight seals between respective lengths of fifth and sixth fluid distribution conduits 130 and 330 and the apertures in the airtight housing 100 through which the lengths of fifth and sixth fluid distribution conduits 130 and 330 pass.

When a chilled fluid, usually water, is carried and regulated by the assembly of components included in the commissioning module, the temperature of the fluid encourages water vapour in the air in the vicinity of the commissioning module to condense on components of the commissioning module. When a commissioning module without an airtight housing is positioned in a roof or floor space of a building, the condensate is likely to spread from the commissioning module into the roof or floor space. The presence of condensate in the roof or floor space of a building encourages the growth of moulds and fungi in the roof or floor space, representing serious damage to the fabric of the building. Further, moisture accumulating in a floor space is likely to find its way to the level immediately below the floor space into, for example, ceiling-mounted tiles and other fixtures at the level immediately below the floor space.

The airtight condition of the housing 100 serves to confine any condensate formed on the commissioning module to being that corresponding to the moisture in the air in the housing 100, thereby preventing or, at least, minimising the formation of condensate outside the housing 100, from the air outside the housing 100.

A further consideration is that matter which finds the presence of condensate congenial to growth is, at least, confined to the housing 100. Such matter may include organisms that are undesirable in air ingested by humans, since the organisms may be harmful to humans ingesting them. The airtight condition of the housing 100 serves to restrict mixing of the air in the airtight housing 100 and air outside the airtight housing 100, thereby preventing, or at least minimising, the transfer of, possibly, undesirable organisms from within the airtight housing 100 to the air outside the housing 100.

Although the rectangular housing 100 described is a convenient shape for the airtight housing for the commissioning module, it will be understood that the airtight housing may be of any one of a variety of available shapes and may, in fact, be tailored to fit into a specific available space. The housing 100 may be hung from a ceiling or placed below raised floor panels.

The commissioning module enclosed within the airtight housing 100 serves the function of providing working fluid, usually water, received by way of the flow conduit 1 to the first, third and fifth fluid distribution conduits 103, 104 and 105 and returning exhaust fluid by way of the second, fourth and sixth fluid distribution conduits 106, 107 and 108 to the return conduit 35, at rates that may be varied by the commissioning module.

The commissioning module also serves the purpose of effecting the initial cleaning (by flushing) of the network to which it is connected, and itself, following its installation with the network and, subsequently, effecting orifice plates 21, 22, 23 and 24 are selected to measure the flow rates for the respective fluid supply-exhaust lines 11-31, 12-32, 13-33 and 14-34. The fifth double regulating valve 30 effects adjustment of the overall flow rate and the double regulating valves 25, 26, 27 and 28 effect the adjustment of the individual flow rates for the respective fluid supply-exhaust lines 11-31, 12-32, 13-33 and 14-34. The automatic air vent 19 operates to vent air from the system when the third isolating valve 18 is open. The strainer 4 serves as a filter and removes particulate material from the working fluid. The test points 3 and 5 permit the monitoring of the pressure drop across the strainer 4, a rise in the pressure drop indicating the need to remove and clean the strainer 4. Closure of the first isolating valve 2 effects the shut-off of supply fluid for removal of the strainer 4 or for any other reason requiring the shut-off of supply fluid. The first and second drain-off cocks 6 and 17 permit the system to be drained of fluid when the first isolating valve 2 is shut.

The commissioning module permits the filling and pressure testing of a fluid distribution system to which it belongs by use of the test point 15 for monitoring the fluid supply pressure and the test point 20 for monitoring the fluid exhaust pressure. The fluid flow rates throughout the fluid distribution system are balanced in order to ensure that all parts of the system receive an adequate proportion of the total flow from the supply by the use of the double regulating valves 25, 26, 27 and 28. The commissioning module itself is flushed and cleaned by opening the second isolating valve 16, the strainer 4 effecting the removal of dirt, and the system as a whole is flushed and cleaned by closure of the second isolating valve 16. the setting-up of the appropriate rates of flow in the fluid distribution conduits 103 to 108, which form part of the network.

For the performance of its functions, the commissioning module may include:

a plurality of fluid distribution valves so connected together as to provide a first through-port communicating with a second through-port by way of a fluid passage, the fluid distribution valves including respective fluid outlet ports communicating with the fluid passage through fluid flow-control means,

a first isolating valve including an inlet port and an outlet port, the outlet port being connected to the first through port of the plurality of fluid distribution valves and the inlet port providing a fluid supply port of the commissioning module,

further isolating valve means including an inlet port and an outlet port, the inlet port being connected to the second through-port of the plurality of fluid-distribution valves and the outlet port being connected to a combined fluid-exhaust port of the commissioning module,

a plurality of fluid flow-regulating valves, the same in number as there are fluid-distribution valves, including respective inlet and outlet ports, the outlet ports being connected to the combined fluid-exhaust port of the commissioning module,

a further fluid flow-regulating valve connected between the combined fluid-exhaust port and a further fluid exhaust port of the commissioning module,

flow-rate measuring means connected between the further fluid flow-regulating valve and the combined fluid-exhaust port of the commissioning module and

at least one drain-off cock connected to permit the draining of fluid from the commissioning module.

Referring to FIG. 2 of the accompanying drawings, the commissioning module includes a first isolating valve 2, a strainer 4, a first drain-off cock 6, first, second, third and fourth fluid-distribution valves 7, 8, 9, and 10, a second isolating valve 16, a second drain-off cock 17, a third isolating valve 18, an automatic air vent 19, first, second, third and fourth orifice plates 21, 22, 23 and 24, first, second, third and fourth double regulating valves 25, 26, 27 and 28, a fifth orifice plate 29 and a fifth double regulating valve 30. The commissioning module further includes a first and second test points 3 and 5 between which lie the strainer 4, a third test point 15 which is adjacent to a port of the second isolating valve 16 and a fourth test point 20 which is adjacent to a port of the third isolating valve 18.

The first isolating valve 2 has a fluid-inlet and a fluid-outlet port, the fluid-inlet port of the first isolating valve 2 providing a fluid-supply port for the commissioning module and being, in use, connected to the length of fluid-supply (or flow) conduit 1. The strainer 4 has a fluid-inlet port and a fluid-outlet port. The fluid-outlet port of the first isolating valve 2 is connected to the fluid-inlet port of the strainer 4. The fluid-outlet port of the strainer 4 is connected to a fluid-inlet port of a drain off cock 6 and the fluid-outlet port of the strainer 4 is also connected to the first fluid-distribution valve 7.

The fluid-outlet port of the strainer 4 is connected to the first through-port of the first fluid-distribution valve 7. The second through-port of the first fluid-distribution valve 7 is connected to the first through-port of the second fluid-distribution valve 8, the second through-port of the second fluid-distribution valve 8 is connected to the first through-port of the third fluid-distribution valve 9 and the second through-port of the third fluid-distribution valve 9 is connected to the first through-port of the fourth fluid-distribution valve 10. The output ports of the first, second, third and fourth fluid-distribution valves 7, 8, 9 and 10 are shown connected to supply fluid or fluid flow lines 11, 12, 13 and 14, respectively, for connection to a fluid-distribution system or network which may include the commissioning module.

Comparing FIGS. 1 and 2, the fluid distribution conduits 103 to 105 of FIG. 1 correspond to the supply fluid lines 11 to 13, say, of FIG. 2, the module shown in FIG. 2 being, in fact, suitable for supplying fluid to four services whereas the module shown in FIG. 1 supplies only three services.

Referring to FIG. 2, the second through-port of the fourth fluid-distribution valve 10 is connected to the inlet port of the second isolating valve 16. The outlet port of the second isolating valve 16 is connected to the inlet port of a third isolating valve 18 and to the second drain-off cock 17. The outlet port of the third isolating valve 18 is connected to an automatic air vent 19.

The second isolating valve 16, which is usually shut, serves to separate the fluid-supply or fluid-flow part of a fluid-distribution system, which includes the commissioning module, from the fluid-exhaust or fluid-return part of the fluid-distribution system. When the second isolating valve 16 is open it serves as a bypass route between the fluid-supply and fluid-exhaust parts of the system. Consequently, the second drain-off cock 17, the third isolating valve 18 and the automatic air vent serve as components of the fluid-exhaust part of the fluid-distribution system.

A fluid-exhaust line 31 of a fluid-distribution system which includes the commissioning module is connected to the inlet port of the first orifice plate 21 which has an inlet port and an outlet port. The outlet port of the orifice plate is connected to the inlet port of the first double regulating valve 25 and the outlet port of the double regulating valve 25 is connected to the outlet port of the second isolating valve 16.

Further fluid-exhaust lines 32, 33 and 34 of the fluid-distribution system are connected to the respective inlet ports of the second, third and fourth orifice plates 22, 23 and 24. The outlet ports of the orifice plates are connected to the inlet ports of the double regulating valves 26, 27 and 28, respectively, and the outlet ports of the double regulating valves 26, 27 and 28 are connected to the outlet port of the second isolating valve 16 by means of a length of conduit 36 serving as a combined fluid-exhaust port. The outlet ports of the double regulating valves 25, 26, 27 and 28 are connected also to the inlet port of the fifth orifice plate 29. The outlet port of the fifth orifice plate 29 is connected to the inlet port of the fifth double regulating valve 30 and the outlet port of the fifth double regulating valve 30 is connected to the fluid return conduit 35.

Comparing FIGS. 1 and 2, the fluid distribution conduits 106 to 108 of FIG. 1 correspond to the fluid exhaust lines 31 to 33, say, of FIG. 2, the module shown in FIG. 2 being, as is indicated above, suitable for supplying fluid to four services whereas the module shown in FIG. 1 supplies only three services.

Alternative arrangements include the positioning of the second drain-off cock 17, the third isolating valve 18 and the automatic air vent 19 adjacent to the fourth double regulating valve 28 rather than as shown in FIG. 2 where the second drain-off cock 17, the third isolating valve 18 and the automatic air vent 19 are positioned adjacent to the first double regulating valve 25.

As is shown in FIG. 2, the fluid-distribution valves 7, 8, 9 and 10 are so grouped together as to form a fluid supply-manifold, the first through-port of the first fluid distribution valve 7 and the second through-port of the fourth fluid-distribution valve 10 providing through-ports of the fluid supply-manifold, there being a through-passage between those through-ports of the manifold.

Also as shown in FIG. 2, the first, second, third and fourth orifice plates 21, 22, 23 and 24 with the first, second, third and fourth double regulating valves 25, 26, 27 and 28 are so grouped together with appropriate connection components, including the length of fluid conduit 36, as to form a fluid exhaust-manifold.

The commissioning module functions as follows:

The fluid-distribution valves 7, 8, 9 and 10 supply a working fluid to respective heat exchangers by way of fluid supply lines 11, 12, 13 and 14 and the working fluid returns from the heat exchangers by way of fluid exhaust lines 31, 32, 33 and 34. The exhaust flow of the working fluid passes through the orifice plates 21, 22, 23 and 24 to the double regulating valves 25, 26, 27 and 28 to the fifth orifice plate 29 and to the fifth double regulating valve 30. The fifth orifice plate 25 is used to measure the overall flow rate for the commissioning module (the pressure drop across an orifice plate is an indication of flow rate) and the

Specific aspects of the commissioning module include:

the provision of the single strainer 4, the single bypass valve 16 and drain-off cocks 6 and 17 capable of serving a fluid-distribution system including several heat exchangers,

The strainer 4 may be omitted and flow-rate measurement devices other than orifice plates may be used,

any form of fluid-regulating valve could be used rather than double regulating valves,

the provision of the air vent 19 at a position permitting the venting of several heat exchangers.

Although referred to as an air vent, the vent 19 would, of course, vent any gas in the fluid-distribution system,

The access points are few in number and commissioning of the fluid-distribution system, being executed principally from the commissioning module, is effected with reduced need for access to other parts of the system and, consequently, reduced disturbance to adjacent structures.

The working fluid is most usually water which is heated for a heating system and cooled for a cooling system, the heat exchangers being selected as appropriate according to whether heating or cooling is required.

Referring to FIG. 3 of the accompanying drawings, a peripheral wall 400 of the housing 100 (FIG. 1) is penetrated by a length of conduit 401 which is covered by a layer 402 of resilient material which lies in contact with a resilient sealing member 403 lying between the peripheral wall 400 and the end of the resilient covering layer 402 adjacent to the peripheral wall 400. The resilient covering layer 402 closely fits over the length of conduit 401 and provides an airtight seal between itself and the length of conduit 401. The resilient sealing member 403 is plane with an aperture corresponding in size to that of the aperture in the peripheral wall 400. The sealing member 403 may be disc-shaped or may be polygonal, including rectangular.

The resilient sealing member 403 is attached to the peripheral wall 400 by an adhesive and so forms an airtight seal with the peripheral wall 400. The end of the resilient covering layer 402 in contact with the resilient sealing member 403 is attached to the resilient sealing member 403 by an adhesive and the resilient sealing member 403 and the resilient covering layer 402 effect an airtight seal at the aperture in the housing penetrated by the length of conduit 401.

In general, the material of the resilient sealing member 403 is thermally insulating and the material of the resilient covering layer 402 is thermally insulating.

The arrangement shown in FIG. 3 is used where the overall diameter of the length of conduit 401 and its resilient covering layer 402 exceed the diameter of the aperture in the peripheral wall 400. An effective seal may be provided between the resilient sealing member 403 and a bare length of conduit, that is, without a covering layer, sealing being assisted by providing an adhesive between the bare length of conduit and the resilient sealing member and, also, by increasing the thickness of the resilient sealing member.

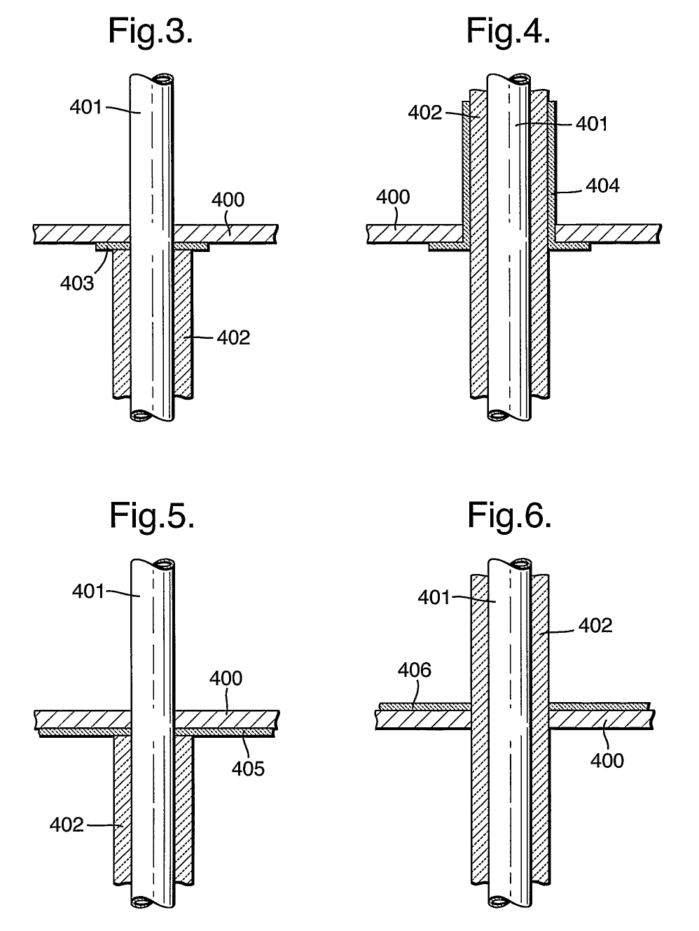

Referring to FIG. 4 of the accompanying drawings, the peripheral wall 400 of the housing 100 (FIG. 1) is penetrated by the length of conduit 401 which is covered by the layer 402 of resilient material. A resilient sealing member 404 includes a cylindrical portion with a flange at one end, the cylindrical portion extending into the housing 100 (FIG. 1) and the flange occupying the position of the resilient sealing member 403 of FIG. 3. The cylindrical portion of the resilient sealing member 404 lies between the periphery of the aperture in the peripheral wall 400 and the surface of the resilient covering layer 402. The resilient covering layer 402 closely fits over the length of conduit 401 and provides an airtight seal between itself and the length of conduit 401.

The flange of the resilient sealing member 404 is attached to the peripheral wall 400 by an adhesive and so forms an airtight seal with the peripheral wall 400. The surface of the resilient covering layer 402 in contact with the resilient sealing member 404 is attached to the resilient sealing member 404 by an adhesive and the resilient sealing member 404 and the resilient covering layer 402 effect an airtight seal at the aperture in the housing penetrated by the length of conduit 401.

As before, in general, the material of the resilient sealing member 404 is thermally insulating.

The arrangement shown in FIG. 4 is used where the overall diameter of the length of conduit 401 with its resilient covering layer 402 is the same as the diameter of the aperture in the peripheral wall 400. An effective seal may be provided between the resilient sealing member 404 and a bare length of conduit, that is, without a covering layer, sealing being assisted by providing an adhesive between the bare length of conduit and the resilient sealing member.

The resilient sealing member 403 of FIG. 3 is, in effect, a grommet and the resilient sealing member 404 of FIG. 4 is a grommet or a grommet sleeve. Other suitable sealing members include cable glands.

Referring to FIG. 5 of the accompanying drawings, the peripheral wall 400 of the housing 100 (FIG. 1) is penetrated by the length of conduit 401 which is covered by the layer 402 of resilient material. In the case of the FIG. 5 arrangement, a plurality of discrete sealing members 403 of FIG. 3 are merged into a resilient sealing layer 405 lying between the peripheral wall 400 and the end of the resilient covering layer 402 adjacent to the peripheral wall 400. The resilient covering layer 402 closely fits over the length of conduit 401 and provides an airtight seal between itself and the length of conduit 401. The resilient sealing layer 405 includes respective apertures corresponding in size and position to the apertures in the peripheral wall 400.

The resilient sealing layer 405 is attached to the peripheral wall 400 by an adhesive and so forms an airtight seal with the peripheral wall 400. The end of the resilient covering layer 402 in contact with the resilient sealing layer 405 is attached to the resilient sealing layer 405 by an adhesive and the resilient sealing layer 405 and the resilient covering layer 402 effect an airtight seal at the aperture in the housing penetrated by the length of conduit 401.

As before, in general, the material of the resilient sealing layer 405 is thermally insulating.

The arrangement shown in FIG. 5 is used where the overall diameter of the length of conduit 401 and its resilient covering layer 402 exceed the diameter of the aperture in the peripheral wall 400. An effective seal may be provided between the resilient sealing layer 405 and a bare length of conduit, that is, without a covering layer, sealing being assisted by providing an adhesive between the bare length of conduit and the resilient sealing layer and, also, by increasing the thickness of the resilient sealing layer.

Referring to FIG. 6 of the accompanying drawings, the peripheral wall 400 of the housing 100 (FIG. 1) is penetrated by the length of conduit 401 which is covered by the layer 402 of resilient material. In this case, a resilient sealing layer 406 is placed on the inside of the peripheral wall 400 instead of on the outside as for the resilient sealing layer 405 of FIG. 5. The resilient covering layer 402 closely fits over the length of conduit 401 and provides an airtight seal between itself and the length of conduit 401. The resilient sealing layer 406 includes respective apertures corresponding in size and position to the apertures in the peripheral wall 400.

The resilient sealing layer 406 is attached to the inside of the peripheral wall 400 by an adhesive and so forms an airtight seal with the peripheral wall 400. The resilient covering layer 402 penetrates the peripheral wall 400 and the surface of the resilient covering layer 402 lies in contact with the resilient sealing layer 406. the resilient covering layer 402 is attached to the resilient sealing layer 406 by an adhesive and the resilient sealing layer 406 and the resilient covering layer 402 effect an airtight seal at the aperture in the housing penetrated by the length of conduit 401.

As before, in general, the material of the resilient sealing layer 406 is thermally insulating.

The arrangement shown in FIG. 6 is used where the overall diameter of the length of conduit 401 with its resilient covering layer 402 is the same as the diameter of the aperture in the peripheral wall 400. An effective seal may be provided between the resilient sealing layer 406 and a bare length of conduit, that is, without a covering layer, sealing being assisted by providing an adhesive between the bare length of conduit and the resilient sealing member and, also, by increasing the thickness of the resilient sealing member.

Suitable resilient materials include plastics and rubber which may be foamed or may be non-foamed. Suitable plastics include polythene and polystyrene.

1 . A commissioning module including:
an assembly of fluid control elements including a main fluid supply port, a main fluid return port, a first fluid distribution port and a second fluid distribution port, the assembly of fluid control elements being operable to pass supply fluid from the main fluid supply port to the first fluid distribution port and to pass return fluid entering the second fluid distribution port to the main fluid return port, at a rate that may be varied by at least one of the fluid control elements,
a plurality of lengths of conduit connected to the ports of the assembly of fluid control elements,
a housing enclosing the assembly of fluid control elements, the periphery of the housing including respective apertures through which pass the plurality of lengths of conduit, the housing being airtight except for the apertures in its periphery and
a plurality of sealing members providing airtight seals between the apertures in the periphery of the housing and the respective lengths of conduit passing through the apertures.

2. A module as claimed in claim 1, wherein the sealing members include grommets.

3. A module as claimed in claim 1, wherein the sealing members include grommet sleeves.

4. A module as claimed in claim 1, wherein the sealing members include cable glands.

5. A module as claimed in claim 1, wherein a plurality of sealing members are merged into a layer of resilient material.

6. A module as claimed in claim 1, wherein the sealing members are positioned on the outer surface of the periphery of the housing.

7. A module as claimed in claim 1, wherein the sealing members are positioned on the inner surface of the periphery of the housing.

8. A module as claimed in claim 1, wherein the lengths of conduit include a resilient covering layer.

9. A module as claimed in claim 8, wherein the resilient covering layer is a plastics material.

10. A module as claimed in claim 8, wherein the resilient covering layer is of a foamed material.

11. A module as claimed in claim 1, wherein the sealing members are of a plastics material.

12. A module as claimed in claim 1, wherein the sealing members are of a foamed material.

13. A module as claimed in claim 1, wherein the housing includes a lid, sealing means being included for effecting an airtight seal between the lid and the remainder of the housing, when the lid is fitted.

14. A module as claimed in claim 1, wherein the assembly of fluid control elements includes elements operable to effect the flushing through of the assembly.

15. A module as claimed in claim 1, wherein the assembly of fluid control elements includes:
a plurality of fluid distribution valves so connected together as to provide a first through-port communicating with a second through-port by way of a fluid passage, the fluid distribution valves including respective fluid outlet ports communicating with the fluid passage through fluid flow-control means,
a first isolating valve including an inlet port and an outlet port, the outlet port being connected to the first through port of the plurality of fluid distribution valves and the inlet port providing a fluid supply port of the commissioning module,
further isolating valve means including an inlet port and an outlet port, the inlet port being connected to the second through-port of the plurality of fluid-distribution valves and the outlet port being connected to a combined fluid-exhaust port of the commissioning module,
a plurality of fluid flow-regulating valves, the same in number as there are fluid-distribution valves, including respective inlet and outlet ports, the outlet ports being connected to the combined fluid-exhaust port of the commissioning module,
a further fluid flow-regulating valve connected between the combined fluid-exhaust port and a further fluid exhaust port of the commissioning module,
flow-rate measuring means connected between the further fluid flow-regulating valve and the combined fluid-exhaust port of the commissioning module and
at least one drain-off cock connected to permit the draining of fluid from the commissioning module.

16. A module substantially as herein described with reference to and as shown in the accompanying drawings.

17. A module as claimed in claim 2, wherein a plurality of sealing members are merged into a layer of resilient material.

18. A module as claimed in claim 3, wherein a plurality of sealing members are merged into a layer of resilient material.

19. A module as claimed in claim 2, wherein the sealing members are positioned on the outer surface of the periphery of the housing.

20. A module as claimed in claim 5, wherein the sealing members are positioned on the outer surface of the periphery of the housing.
